(19) United States
(12) Patent Application Publication
(10) Pub. No.: US 2006/0080301 A1
(43) Pub. Date: Apr. 13, 2006

(54) Software system to allow creation of customized database search screens

(76) Inventor: Ronald Norman Cole, Arlington, VA (US)

Correspondence Address: Ronald N. Cole, Apt 24, 1967 Columbia Pike, Arlington, VA, 22204, US

(21) Appl. No.: 11/227,878

(22) Filed: Sep. 15, 2005

Related U.S. Application Data
(60) Provisional application No. 60/613,051, filed on Sep. 24, 2004.

(51) Int. Cl. G06F 17/30

(52) U.S. Cl. 707/3

(57) ABSTRACT

Computer users frequently need to search for items, such as inventory, based on specific criteria. The specific criteria used are often dependent upon the task they are performing. For example, if they are looking for books they may search by ‘title’. If they are looking for cars they may look by ‘engine type’. This invention allows a user to create the search screens (with places to enter the values for the pertinent fields) automatically by the use of a software wizard. This invention extracts information about the database, and then creates the steps necessary for the person creating the search screen to create it. The person creating the search screen can control what fields the search screen user will be able to search on, how the data will be filtered and/or manipulated, how it will be formatted, and how it will be presented. This provides a tremendous productivity boost to the search screen user, since much of the filtering and decision-making will have been done before hand. Also, by using a wizard to allow the rapid creation of searches, the door is opened for ‘rapid application development.’ This allows non-programmers the ability to create, rapidly deploy, test and refine their own searches.

### CROSS-REFERENCE TO RELATED APPLICATIONS

This application claims the benefit of provisional patent application Ser. No. 60/613,051 filed Sep. 24, 2004.

### FEDERALLY SPONSORED RESEARCH

Not applicable

### SEQUENCE LISTING OR PROGRAM

The code to perform this (Java class files, PL/SQL code and Java Server Pages) is contained on the enclosed CD-ROMs.

### BACKGROUND OF THE INVENTION

1. Field of Invention

This invention allows the rapid creation of customized search screens by the use of a software wizard. The search screens created can then be used by people looking for information to help them perform specific tasks, where much of the data not related to the task at hand has been removed, and the data return from the search has been formatted and potentially modified to user complete their task.

2. Prior Art

Both software wizards and search screens have been common software concepts for decades. A wizard is a series of screens presented to a user that ask him or her for specific information. A search screen presents a user with field(s) in which to enter in search criteria. A common example of a specific search screen is that used in looking up books. One frequently enters in fields such as title, author, publisher, etc.

Customized searches have been created for specific needs of companies in the past by hand coding them. That is, a programmer has written the code for that particular search screen. This method is completely customizable, but slow, expensive and risky. Projects to create customized searches may fail—leaving the company worse off than before.

Due to the recent explosion of information, search Technology has become a very hot topic of interest. Patents such as U.S. Pat. No. 6,868,409, represent how people are looking to use automated algorithms to separate out information. This method is a departure from those sorts of methods in that it allows a human being to make the critical decisions when it comes to what fields to include in the search.

### OBJECTS AND ADVANTAGES

Accordingly, several objects and advantages of my invention are

Objects:

The invention will allow some users to create or edit searches that can be used by themselves and other users.

The invention will allow the creation of searches that pre-select some aspects of the data.

The invention will allow the creation of searches that format how the data returned will be displayed based on its attributes. For example, a search screen may be created to only return information pertinent to the area in which it was used.

The invention may allow the creation of searches that numerically modify data based on the data's attributes.

The invention may allow the creation of searches that partition the data based on the data's attributes.

The invention may allow the establishment of some default values to be entered into searches, which the search user may have the ability to change.

Advantages:

By allowing the creation of a particular search based on a wizard type of system, users can focus the searches they perform to pre-established criteria, and see the data returned formatted (via color, or font or other symbols) to contain more information. This provides a tremendous productivity boost, since much of the filtering and decision-making have been done before hand.

By using a wizard to allow the rapid creation of searches, the door is opened for ‘rapid application development.’ This allows non-programmers the ability to create, rapidly deploy, test and refine their own searches.

Further objects and advantages of my invention will become apparent from a consideration of the drawings and ensuing description.

### SUMMARY

Using a software wizard to allow the creation of customized searches allows the rapid deployment of highly specific, context-driven, intelligently formatted views of the available data. Customized searches have not been created like this in the past. By allowing the creator of the search to select which specific search fields will be available, certain parameters limiting the search output and controlling the formatting of the output results (thus letting the context in which the search is done determine much about what data is returned and how it appears) one can reduce the amount of extemporaneous data that a user must look through, and hence greatly improve user productivity.

### DRAWINGS

FIG. 1—a representation of the installation process that shows important aspects of this invention

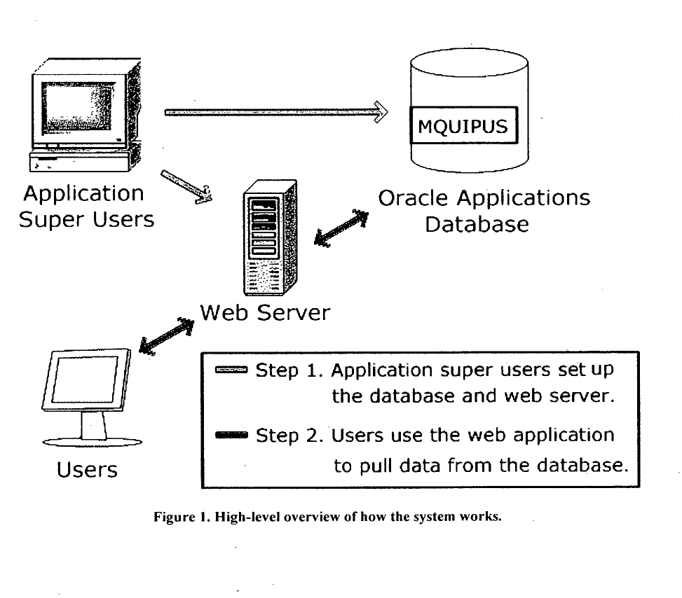

FIG. 2—a view of what a sample search created by this system could look like

FIG. 3—a view of a page to allow the creation of a new search, or the editing of an existing search.

FIG. 4—a view of a page to allow user to name and describe a particular search

FIG. 5—a view of a page to allow a user to select a category (in this case catalog) to which data returned by this search must belong

FIG. 6—a view of a page to allow the users to add fields that will be searchable and to provide them with an intuitive display name

FIG. 7—a page to allow the user to automatically exclude some data from the data returned by this search based on an attribute of the data

FIG. 8—a view of a page to allow the user to select an attribute of the data which will be used for color coding

FIG. 9—a view of a page to allow the user to color code data returned by this search based on attributes of that data

FIG. 10—A pop-up window (accessible from color selection page) to allow the further refinement of data selection.

FIG. 11—The standard Java color picker to allow the selection of color.

FIG. 12—a view of a page to allow the user to sort the returned data based on the values in specific fields in it

FIG. 13—a view of a page to allow a user to automatically numerically manipulate some of the data returned by this search

FIG. 14—A pop-up window to allow the user to test the numerical formula enter on the numerical formula page.

FIG. 15—a view of a page to allow the user to partition the data returned by this search into different categories based on attributes in that data

FIG. 16—a view of a page to allow a user to set a default value for an attribute of a search (which the user may be able to override when the search is actually executed)

FIG. 17—a view of a page to see elements of the configuration for a particular search

FIG. 18—A view of further information that can be obtained when a user selects on a part description returned by the search.

### DETAILED DESCRIPTION

### PREFERRED EMBODIMENT

Enclosed is a black and white copy of a User's Guide for the product mqInventory Status. This product represents an embodiment of this new technology, and the User's Guide is included to aid in the understanding of this invention. Also enclosed is a brochure for the product mqInventory Status.

Enclosed on CD-ROMs is the source code listing.

Also on the CD is an executable file to install the software program (component 100) and a war file generated from the source code (component 200).

This particular embodiment of the invention allows for the creation of searches to pull inventory data out of Oracle Applications (trademark of the Oracle Corporation.) Data returned is part data. This will be referred to as data or part data.

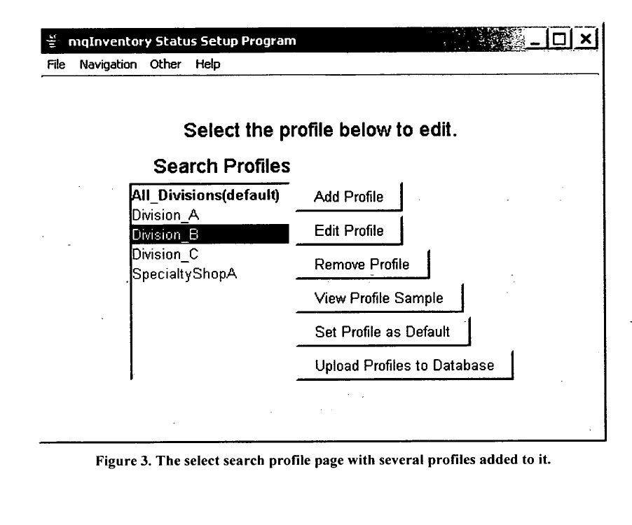

Once the software is installed one can access the page listing information about searches (shown in FIG. 3). From this page they may add/edit/remove/view or set as default any particular search. They may also upload all searches to the database.

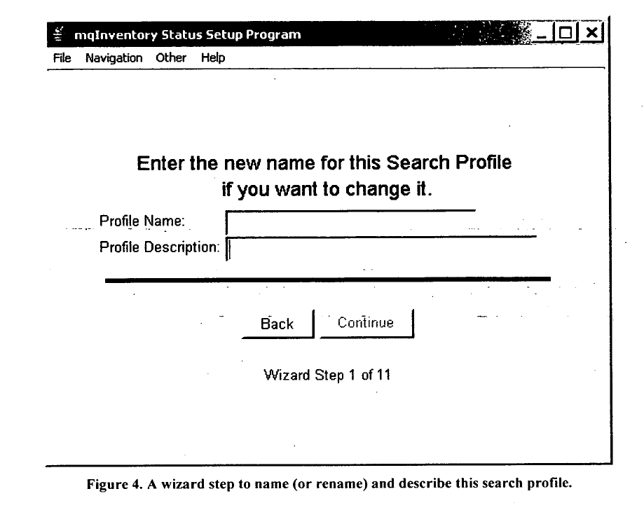

If they choose to add or edit a search, they will be presented with the page shown in FIG. 4. Here they can give the search a meaningful name and description.

The next figures (5-16) show various steps of the wizard that allow the to do distinct operations to the search.

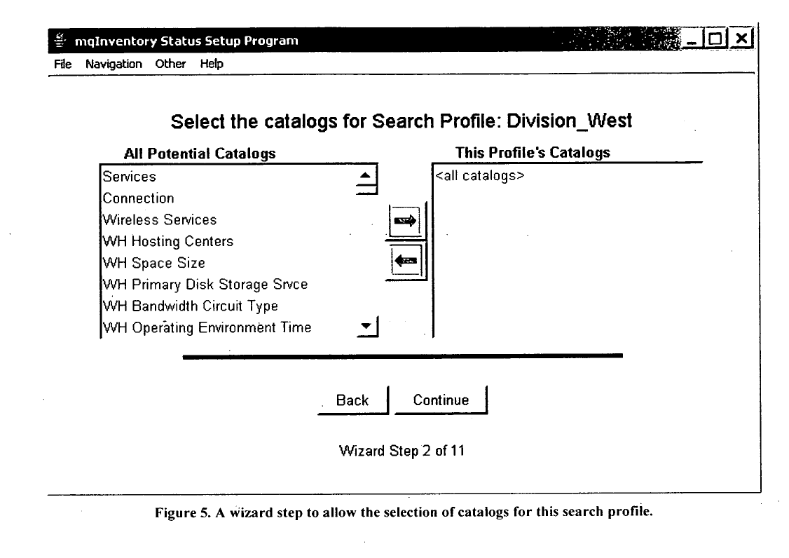

In FIG. 5 is shown a page to allow the search creator to select an aspect of the data (in this case catalog) to allow a search to return. If data belongs to a catalog not selected, it will not be returned by the search.

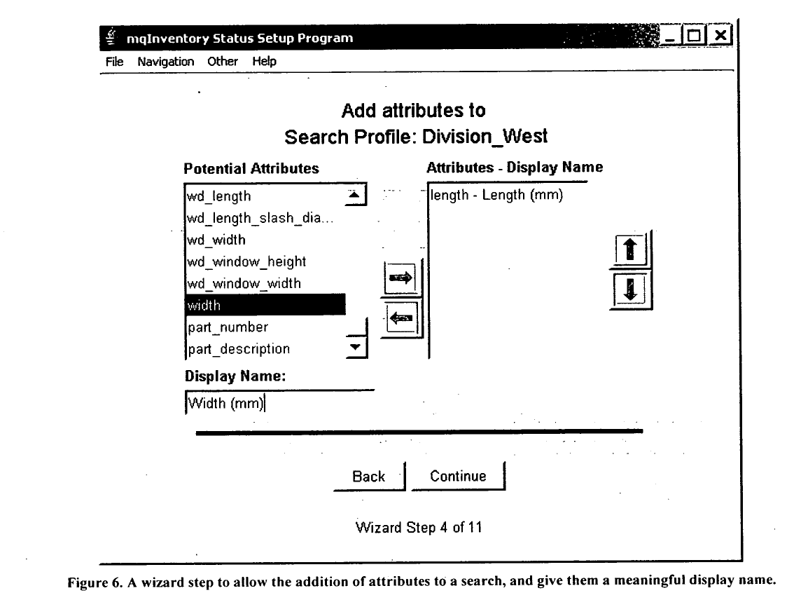

In FIG. 6 is shown a page to allow the user to select the attributes that a user of the search will be able to search by, and the name on the display that will appear when they view the search screen. This is to allow more meaningful labels to be applied to the particular attribute.

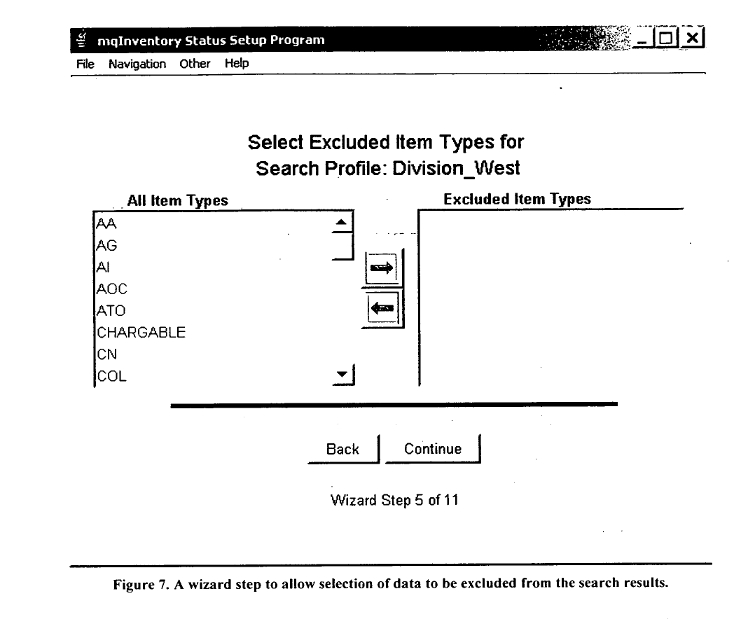

In FIG. 7 is shown a page to allow the search creator to select categories of data to specifically exclude.

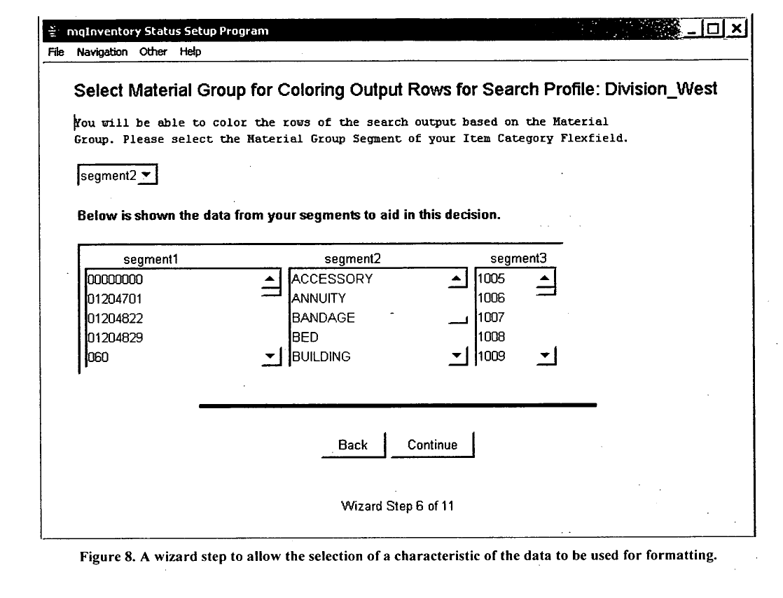

In FIG. 8 is shown a page to allow the user to select a portion of the data (in the parlance of Oracle Applications the ‘segment’) to use for color-coding.

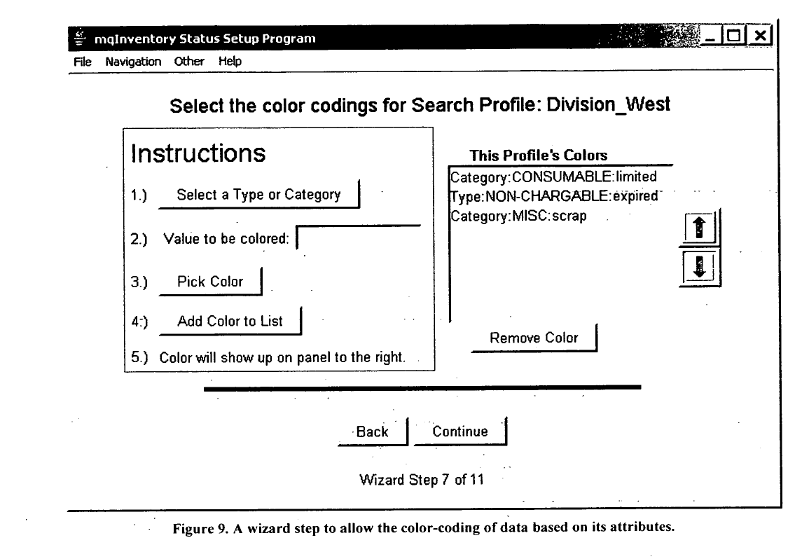

In FIG. 9 is shown a page to apply the color-coding to search results.

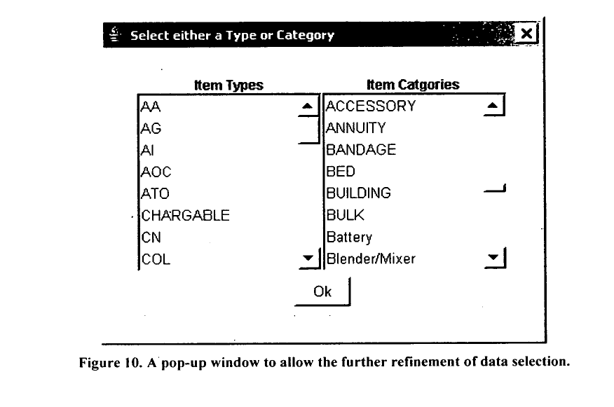

FIG. 10 shows the pop-up window that is reached from selecting the button “Select Type or Category” shown on FIG. 9. This allows the search creator to select the specific data field that will be used for color-coding.

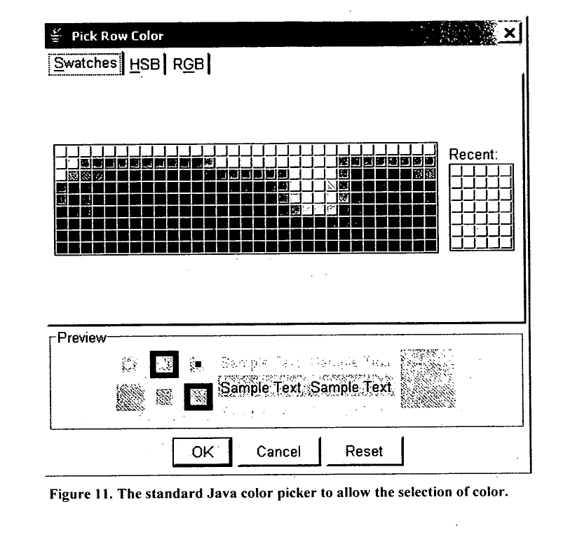

FIG. 11 shows the Java color chooser that is reached from selecting the button “Pick Color” on FIG. 9. This allows them to select a shade of color for data that has specific attributes.

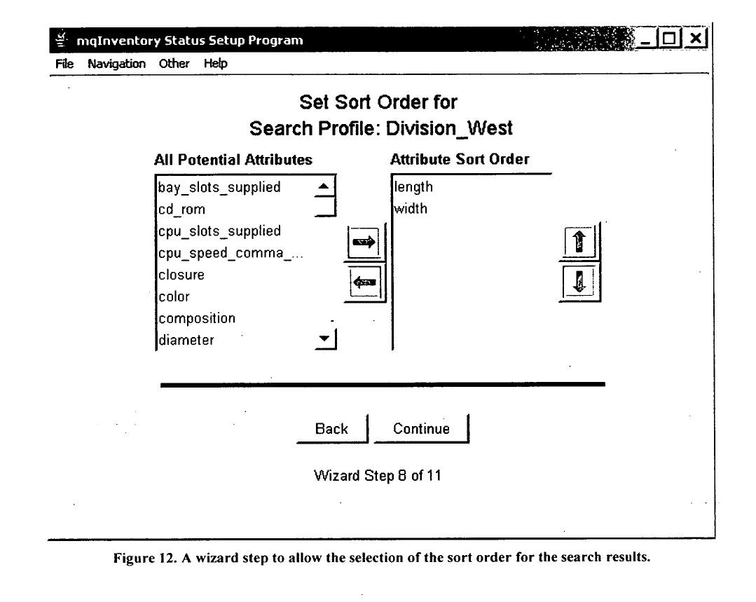

FIG. 12 shows a page to allow the user to select the specific sort order of the data returned. They will choose the fields in which the data will be sorted.

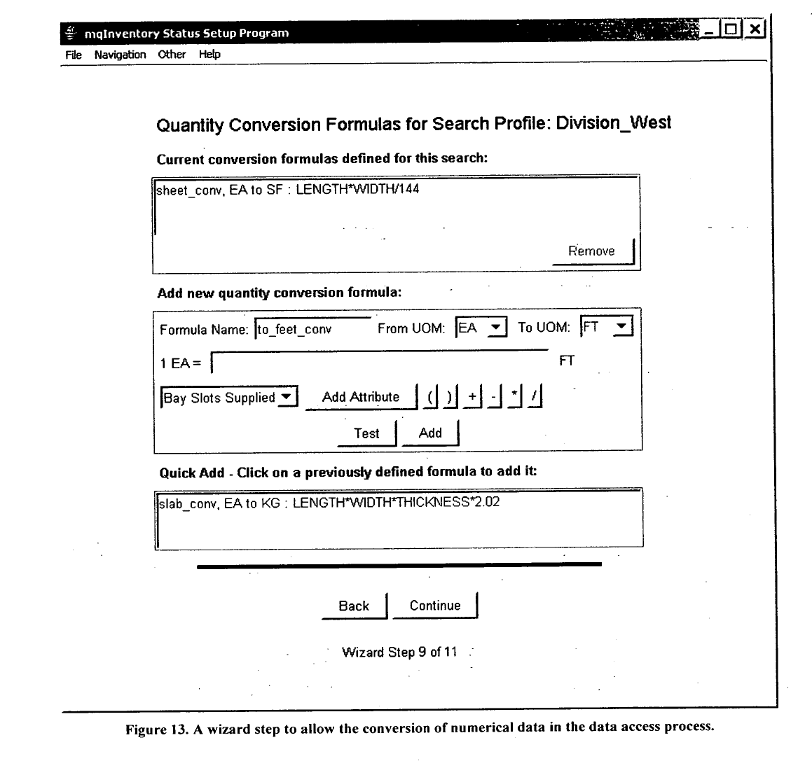

FIG. 13 shows a page to allow the user to enter (or select a previously entered) formula to be applied to the search results. In this case, this formula will be applied when there are unit of measure conversions conducted. For example when the user of the search wants the quantities calculated in terms of square feet but the standard unit of measure is in ‘eaches.’

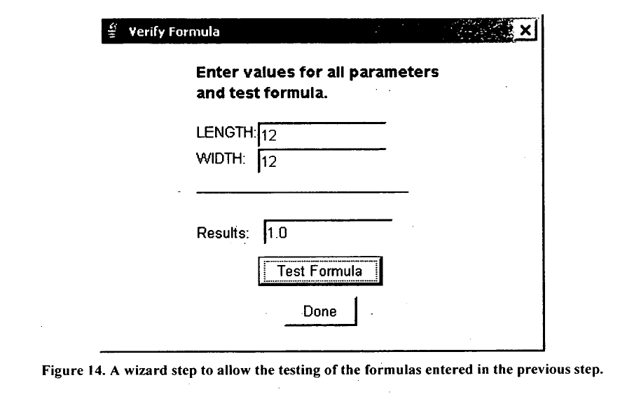

FIG. 14 shows the pop-up window to allow the search creator to test the formula entered in the page shown in FIG. 13.

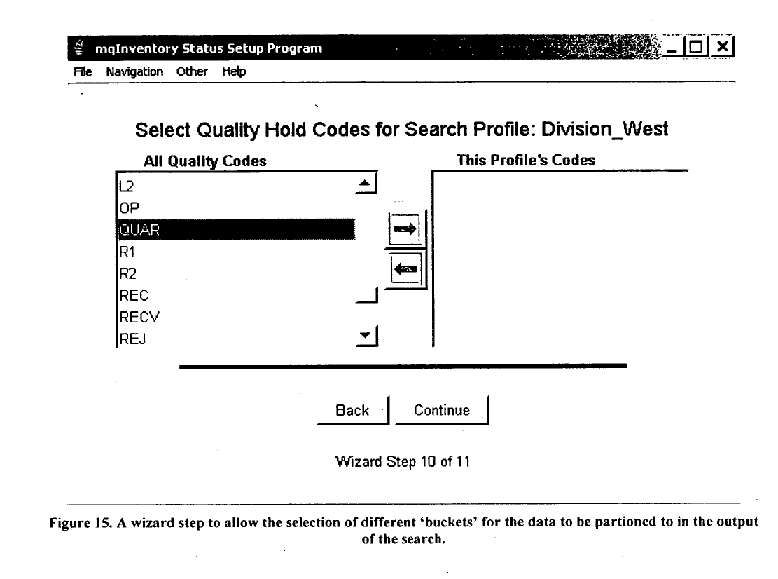

FIG. 15 shows a page to allow a user to select different classifications for the data returned. In this case, they are choosing which codes will indicate that parts are in quality hold.

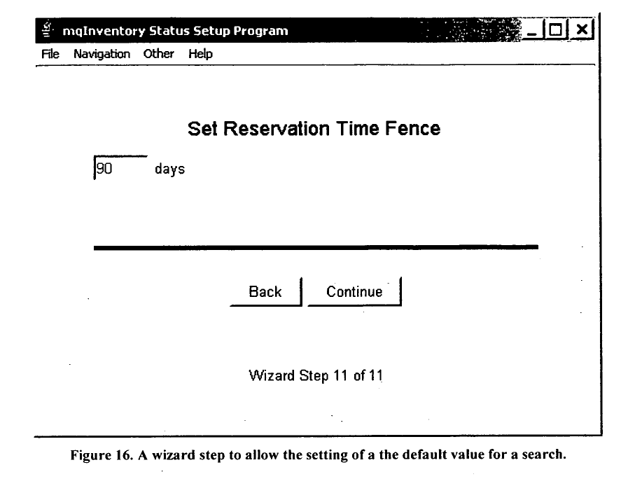

FIG. 16 shows a page to allow the setting of a default value for searches that can then be modified by the user. In this case, the value of data they are setting is the reservation time fence (which is the line separating parts that are on reserve now, and parts that are on reserve in the future.)

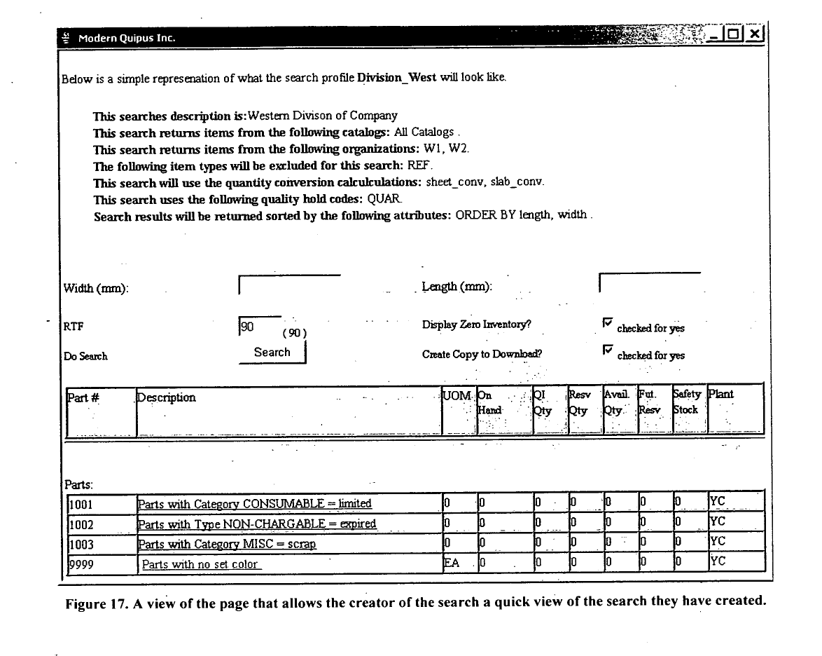

FIG. 17 shows a page to show a particular search. This is access from the page shown in FIG. 3 by selecting a profile and then selecting the ‘View Profile Sample’ button. This page shows the settings that have been selected for the search, and shows a representation of what it will look like.

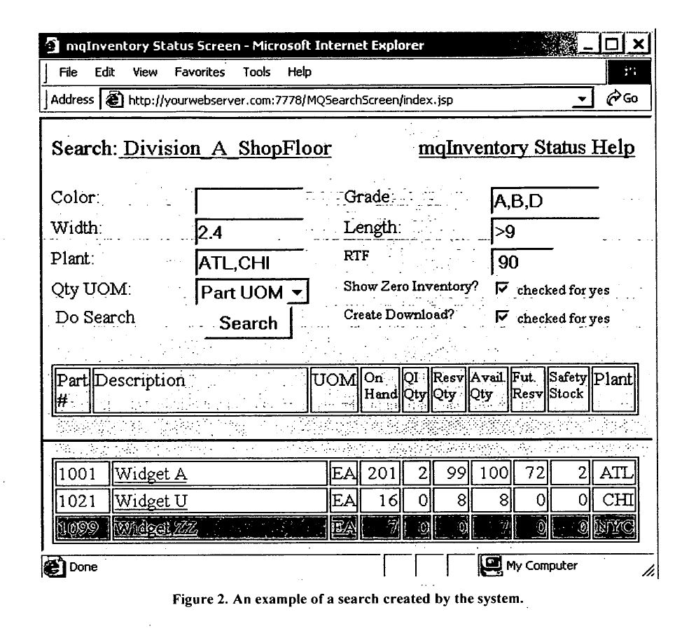

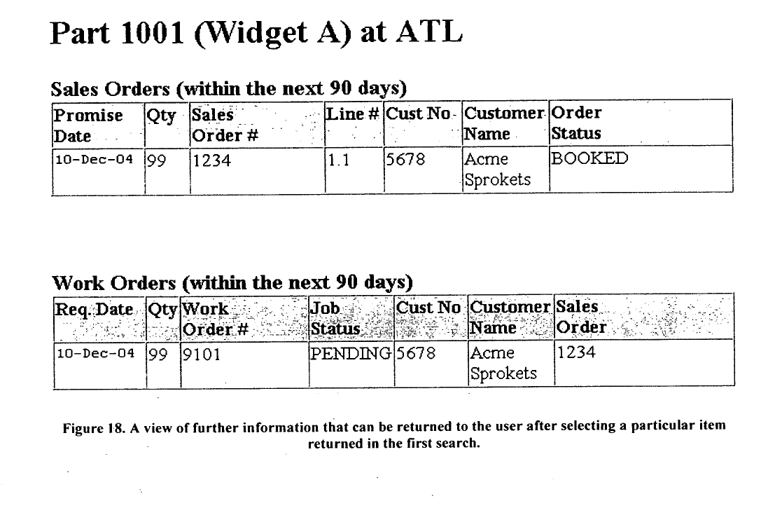

FIG. 18 shows a page that can be reached off of a search page (shown in FIG. 2.) This is reached by selecting the hyperlink on the part description.

### ALTERNATIVE EMBODIMENTS

The specific embodiment presented here is for a system that allows a company to find its inventory efficiently. One alternative embodiment is that this is used to look for non-inventory data.

Another alternative embodiment is that this system to find data is used to pre-select, format and modify data from databases of types other than relational, such as hierarchical databases.

Another alternative embodiment (all ready created but not included when the Provisional Patent Application was submitted) would allow the search creator to select which database tables will be included in the search and the relationship between those tables and the base tables from which searches are created.

### CONCLUSION, RAMIFICATIONS, AND SCOPE

A current crisis of our times is information overload. A system that allows some data filtering decisions to be made when time is not critical is a system that is long overdue. People making time critical conditions can then use their own mental capability better and not become overloaded.

In general, people looking for better data filtering algorithms have been looking in the wrong place. Instead of trying to use computer algorithms to pre-select the data and control its presentation, a human can be used to make these decisions. This invention empowers a human to do so.

1. A method of generating specific context dependent search screens consisting of
(a) a software program to receive user input to create specifications on data available and/or its preferred presentation
(b) a software form of searching data available that limits available data and presents data based on selection made using said software program to receive user inputs
whereby some system users can rapidly create or edit data searches that they and other users can use.
